(19) United States
(12) Patent Application Publication
(10) Pub. No.: US 2001/0052855 A1
(43) Pub. Date: Dec. 20, 2001

(54) Self-contained public identification of a device's owner

(76) Inventor: John W.L. Ogilvie, Salt Lake, UT (US)

Correspondence Address: JOHN W L OGILVIE, COMPUTER LAW, 1211 EAST YALE AVE, SALT LAKE CITY, UT, 84105, US

(21) Appl. No.: 09/747,575

(22) Filed: Dec. 22, 2000

Related U.S. Application Data
(60) Provisional application No. 60/175,334, filed on Jan. 10, 2000.

(51) Int. Cl. G08B 3/00

(52) U.S. Cl. 340/691.6; 340/571; 340/692; 340/426

(57) ABSTRACT

The invention provides tools and techniques for discouraging theft and facilitating recovery of lost devices by placing owner information in a non-volatile memory in the device. The owner information may be entered as an audio recording, as a sequence of typed characters, and in other ways. The owner information includes specific location data, such as the owner's telephone number, email address, and/or postal address. The owner information is easily displayed to the public on the device, without the need to use a specialized reader tool or the need to enter a password or other code to authorize the display. No separate database at a manufacturer or otherwise is needed to correlate the device with the owner's contact information. Instead, the device displays owner information in response to predetermined events, such as power-on, power-off, and/or pushing a “Who Owns Me?” button.

### RELATED APPLICATIONS

This application claims priority to commonly owned copending application serial No. 60/175,334 filed Jan. 10, 2000 as attorney docket no. 1384.2.16 with inventor John W. L. Ogilvie and title “Consumer Electronics Identification”, which is incorporated herein by reference.

### FIELD OF THE INVENTION

The present invention relates to stolen property recovery and theft deterrence, and relates more particularly to tools and techniques for electronically labeling a given device with the owner's identity and contact information in a way which permits the information to be read by the public without any special codes or equipment if the labeled device is lost or stolen.

### TECHNICAL BACKGROUND OF THE INVENTION

Consumers can presently identify their televisions, VCRs, DVD players, CD players, amplifiers, other stereo equipment, WebTV devices, general-purpose computers, and special-purpose computing devices such as medicine-dispensing systems (collectively, “consumer electronics”) by keeping a copy of the manufacturer's serial number in a safe place apart from the device. Some consumers also currently use engraving tools to inscribe their name or social security number in the plastic or other case of a consumer electronics device. If the device is stolen, the serial number and/or engraving can then be used to identify the device. This helps return devices to their proper owners, thereby reducing insurance costs. Reliable identification of goods as stolen also helps law enforcement and criminal prosecution officials bring perpetrators to justice.

However, engravings are permanent. A person who legitimately purchases a used television or consumer electronics device may be unhappy if the device prominently and permanently displays a prior owner's identifying information, by an engraving, name-plate, adhesive label, or otherwise. Engravings and stickers can also be unsightly. Moreover, engravings typically include very limited information such as a last name or initials. Although they can be used to verify a claim of ownership, they are often not very helpful to ordinary people (or even to police) in identifying and contacting the device's rightful owner when that person's contact information is unknown.

Serial numbers are often not recorded by an owner because the initial setup procedure for a new device typically does little more that suggest (in a manual many people do not read completely) that the number be recorded. The serial number recordation is not integrated in the process of installing the device in the buyer's home or business. It also puts the device ID in the consumer's possession for safekeeping; by contrast, the present invention puts the consumer's ID in the device's “possession” so the device itself can identify the owner to police and to honest merchants and others who may come across the device after it is stolen.

Software programs sometimes accept the name of a licensee and (optionally) the name of the licensee's business, and display that name during program initialization and/or in response to a specific menu-driven request to do so. However, this information typically does not include the owner's postal address, telephone number, email address, or similar contact information. Moreover, the licensee name is stored on a disk which can be reformatted, for instance, or otherwise easily manipulated to remove the information. The information is not permanent, unlike consumer identification information in some embodiments of the present invention. Nor is the information permanent subject to password-protection as contemplated by the invention, since a stolen disk can be wiped clean without knowing the owner's password.

Accordingly, there is room for new tools and techniques to help consumers, business, agencies, and other natural and legal persons identify their TVs, stereos, computers, and other devices to discourage theft and to promote owner-device identification in the event of a theft. Such tools and techniques are described and claimed herein.

### BRIEF SUMMARY OF THE INVENTION

The invention provides tools and techniques for discouraging theft and facilitating recovery of lost devices by placing owner information in a non-volatile memory in the device. The owner information may be entered as an audio recording, as a sequence of typed characters, and in other ways. The owner information includes specific location data, such as the owner's telephone number, email address, and/or postal address. The owner information is easily displayed to the public on the device, without the need to use a specialized reader tool or the need to enter a password or other code to authorize the display. No separate database at a manufacturer or otherwise is needed to correlate the device with the owner's contact information. Instead, the device displays owner information in response to predetermined events, such as power-on, power-off, and/or pushing a “Who Owns Me?” button.

Thus, the present invention provides methods, articles, signals, and systems for electronically labeling a given device with the owner's identity and contact information in a way which permits the information to be read by the public without any special codes or equipment if the labeled device is lost or stolen. When a newly manufactured device is initially powered on by the (presumably legitimate) owner, the owner is prompted to enter the owner's name and contact information. The information is stored in the device, and is subsequently displayed on request.

In some embodiments, the owner information is stored permanently, so it cannot be easily changed by a consumer even if the consumer has legitimately purchased the device from the original owner, but can be changed by an authorized factory or dealer service technician who is satisfied as to the legitimacy of the second owner's request. In other embodiments, the owner information can be changed by the original owner or by the legitimate new owner after a password or PIN or other code is entered to authorize the change.

In some embodiments the owner information is entered as individual characters, using a touch screen, screen-displayed keyboard, regular keyboard, remote control, or other familiar character-oriented data input device. In other embodiments the owner information is entered as a voice recording, using a microphone and possibly an analog-to-digital circuit.

In some embodiments, the owner information is displayed each time the device is powered on. The display may include drawing graphical characters on a computer monitor, television tube, or other visual display means. Alternately or in addition to a visual display, the “display” step may play back an audio recording of the owner information, or play a voice-synthesized message reciting owner information.

In some embodiments, the owner information is displayed at any time during operation of the device, instead of or in addition to being displayed at device startup, in response to a specific command. The “display owner” command may be entered by pressing a dedicated button, by selecting a menu item, by stating the request in a voice command, or by other familiar command input means.

The device may be any device equipped with electronics to accept, store, and display owner information. Such devices include consumer electronic devices (TV, VCR, DVD player, stereo equipment, electric guitars, etc.); a growing number of consumer appliances such as “smart” stoves and refrigerators; suitably equipped cars, trucks, snowmobiles, motorcycles, airplanes, and other vehicles; computers (desktop, laptop, handheld, and otherwise); and other items. In particular, many of the non-jewelry types of items that one finds in pawn shops can be equipped with electronic self-identification circuits and/or software that function according to the present invention.

Other aspects and advantages of the present invention will become more fully apparent through the following description.

### BRIEF DESCRIPTION OF THE DRAWINGS

To illustrate the manner in which the advantages and features of the invention are obtained, a more particular description of the invention will be given with reference to the attached drawings. These drawings only illustrate selected aspects of the invention and thus do not limit the invention's scope. In the drawings:

FIG. 1 shows a television equipped according to the invention, as it displays a user prompt for owner information during initial installation of the television by its original owner.

FIG. 2 is a schematic diagram illustrating components of a device equipped to accept, store, and display owner information according to the invention.

FIG. 3 is a flowchart showing a method of the present invention for accepting and storing owner information in a device.

FIG. 4 is a flowchart showing a method of the present invention for publicly displaying owner information on a device without requiring a password or other code and without requiring any equipment other than the inventive device.

### DETAILED DESCRIPTION OF THE PREFERRED EMBODIMENTS

In describing methods, devices, signals, programs, products, and systems according to the invention, the meaning of several important terms is clarified, so the claims must be read with careful attention to these clarifications. Specific examples are given to illustrate aspects of the invention, but those of skill in the relevant art(s) will understand that other examples may also fall within the meaning of the terms used, and hence within the scope of one or more claims. Important terms may be defined, either explicitly or implicitly, here in the Detailed Description and/or elsewhere in the application file.

In particular, an “embodiment” of the invention may be a system, an article of manufacture, a method, and/or a signal which configures a computer memory or other digital or analog medium.

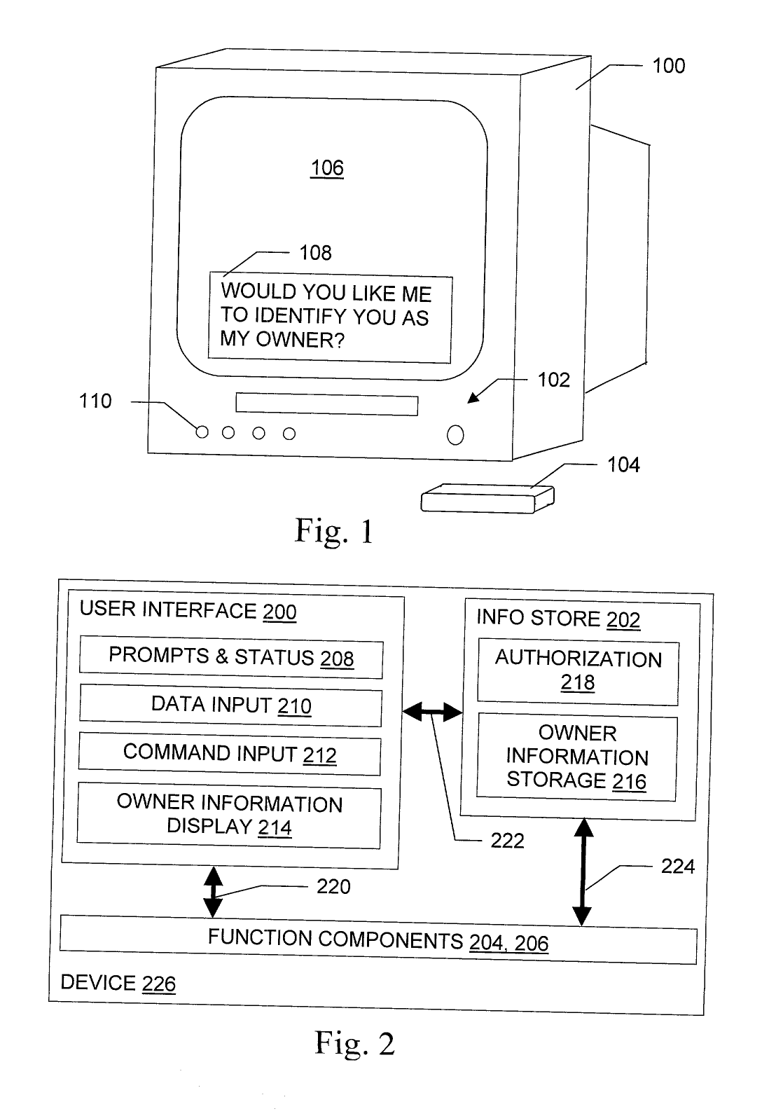

In one embodiment, illustrated in FIG. 1 by reference to a television (TV) set 100, the consumer opens the box, connects the inventive TV 100 to power and possibly to a cable feed, and turns it on. The TV has a control panel 102 with buttons and possibly other command/data input devices. For instance, the TV 100 may accept commands and data from a wireless remote control 104. The TV has a screen 106 for displaying televised images, and also for displaying menus (including dialog boxes, menu items, helpful tips, etc.). In the illustrated embodiment, a TV setup routine presents the consumer with a menu option 108 for entering consumer identification information. A similar visual prompt can be given in other embodiments, such as suitably equipped computers and other consumer electronic devices that have a menu-driven visual display. The illustrated embodiment also includes a microphone 110 for accepting owner information in audible form rather than (or in addition to) owner information entered character-by-character.

Suitable consumer identification information includes the consumer's name, telephone number, postal address, email address, and/or other contact information. The user's name by itself is not sufficient to serve as “owner information”, and neither is the owner's name with merely the owner's business name, because they do not identify the owner sufficiently to permit a member of the public or the police to contact the owner after encountering the stolen or lost device. The owner information must contain at least one location field, such as an email address domain name, a telephone number area code, a street address, and/or a city, state, province, or similar geographic identifier. That is, owner information will merely confirm a statement by an owner who is standing next to the device that the owner's name will appear on the device. Owner information will substantially assist a private citizen or a law enforcement officer to actually locate the owner so the owner can be informed of the device's current location.

FIG. 2 shows suitable components for a device 226 configured according to the invention. Some embodiments may omit or combine some of the components, provided the device still operates as described and claimed. As discussed below, for instance, an authorization module 218 may be omitted, and various user interface 200 functions may be provided by a single circuit board. The device 226 may be a TV set 100, but a wide range of other apparatus may also be configured as a device 226 according to the invention.

A user interface 200 accepts data and commands from a user, provides them to an owner information store 202 and/or to primary function components 204 as appropriate, receives data and/or commands from the components 202, 204, and displays owner information and other information to the user. The user interface 200 may be implemented using buttons, keys, touch screens, a cathode ray tube, LCD or other visual displays, audio speakers, and visual graphic elements such as menus, dialog boxes, highlighting, and so on.

A prompts and status portion 208 of the user interface 200 prompts the user for input, and displays status information regarding owner information and/or other pertinent information. Status information generally may include a low battery indication, a TV cable channel number, a refrigerator internal temperature, a vehicle speed, etc., depending on the primary function of the device 226.

A data input portion 210 of the user interface 200 accepts data from the user. This may be character-oriented data input through a keyboard (either one displayed on a screen or one which has mechanical keys), for instance, and/or audio data input through a microphone. Other familiar data input components may also be used.

A command input portion 212 of the user interface 200 accepts commands from the user. This may be integrated with or replaced by the data input portion 210 in some embodiments. The nature of the commands will vary according to the primary purpose of the device 226. For instance, a television set 100 according to the invention will typically accept a “volume increase” command while a microwave oven according to the invention typically will not. However, embodiments having a wide range of primary purposes will accept a command to display owner information. Other embodiments do not accept such a command, and instead display the owner information only on powering up, on shutting down, or based on some other event which is typically meant to do something other than display the owner information.

An owner information display portion 214 of the user interface 200 obtains the owner information and displays it. Such a display may include a visual display (for sighted persons or using Braille notation), an audible playback of a recorded or synthesized voice, or both. The owner information display portion 214 typically obtains the owner information to display, in the first instance, directly from the user as data input. However, embedded dummy information may be displayed to prompt the user to provide his or her own information. Subsequently the owner information display portion 214 obtains the owner information to display from the information store 202. The owner information display portion 214 may use some or all of the same I/O devices as the other portions 208, 210, 212.

The portions 208-214 are shown and discussed separately merely to clarify the functionality of the user interface 200, not as a strict architectural requirement. In practice the functionality required by the claims may be provided in different embodiments by one or more circuits, subroutines, etc. For instance, a single circuit could perform both data input and command input functions.

The owner information store 202 includes a memory 216 for storing owner information, and optionally includes an authorization module 218 for controlling write access to the memory 216, read access is normally unrestricted, because the owner information should be easily accessed by a member of the public who is trying to identify and locate the device's owner. In embodiments that permit users to enter a PIN, a password, or another code through the interface 200, the authorization module 218 prevents overwriting the memory 216 unless the code matches a previously specified criterion, e.g., it is the same PIN as a PIN previously stored in the memory 216 by the factory or by the original owner when the device is initially set up. If the PINs match, the new owner information overwrites the former information in the memory 216. In such embodiments, the memory preferably uses non-volatile erasable storage such as an EEPROM or flash memory.

In embodiments that do not permit users to change the owner information after it is entered by the original owner, no authorization module 218 is needed. In these embodiments, the memory preferably uses non-volatile non-erasable storage such as an EPROM to hold the owner information.

The primary function components 204 provide the functionality for which the device 226 was primarily purchased or leased. For instance, in a TV set 100 according to the invention, the primary function components 204 include a television receiver, a cathode ray tube or other visual display, and one or more audio speakers. In a car according to the invention, the primary function components 204 include an engine, transmission, wheels, and so on. In other devices 226, the components 204 include things such as a radio receiver, a computer operating system, an internal combustion engine, a heating element, or a refrigeration compressor. In many devices 226, the primary function components 204 are supported by other components 206, such as a power supply, whose presence is not so immediately apparent to users but whose absence prevents the device 226 from functioning properly. The distinction between primary and supporting components is generally not critical to an understanding of the present invention, but is made instead to provide a fuller discussion of devices that may be configured with owner information according to the invention.

As indicated by a link 220, the primary function components 204 and/or supporting components 206 may be configured and/or monitored via the user interface 200. That is, the user interface 200 need not be present solely to permit the acceptance, storage, and display of owner information; the user interface 200 can also be used for normal operation of the device without involving owner information.

As indicated by a link 222, the user interface 200 is the normal path to and from the owner information store's contents. The memory 216 is preferably physically inside the device 226 where a trained technician can reach it but a thief cannot reach it or is, at least, unlikely to try to reach it due to the perceived or actual risk of breaking the device. In some cases, a thief will also be dissuaded from attempting to remove the memory 216 from the device because of the perceived or actual risk of an electric shock if the device's case is opened.

As indicated by a link 224, unauthorized removal of the memory (and hence of the owner information) from the device 226 can also be discouraged by connecting the information store 202 to the components 204 and/or 206. For instance, a power-on self-test may check for the presence of the store 202 and display an error message, fail to function, or function only in a degraded manner, if the store 202 is not found. The test may be passive (simply checking to see if a particular circuit closed) or active (querying the store 202 and verifying that the expected answer was obtained). One simple approach is to run part of the power supply circuit through a package that also contains the store 202, so that power to the device's primary components 204 is interrupted if the package is removed.

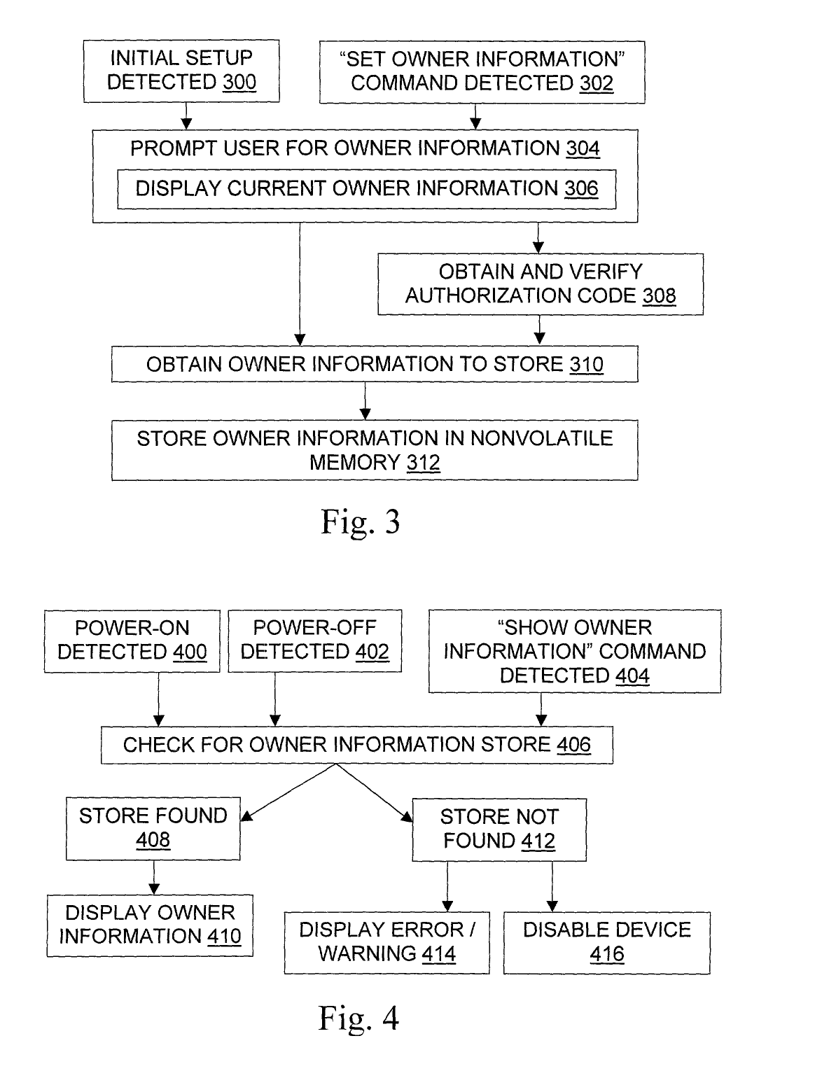

FIG. 3 illustrates methods for obtaining and storing owner information. As indicated, owner information may be sought in response to detecting 300 that the device 226 is being set up for the first time outside the factory, in response to detecting 302 that a suitable command has been entered, or both conditions at various times. That is, some methods omit step 300 and others omit step 302. The “set owner information” command step 302 makes it possible for a second, third, etc. legitimate owner of a device 226 to enter his or her personal owner information in the device, preferably after entering a PIN or other password provided by the previous owner. Thus, subsequent legitimate owners can place their owner information in legitimately acquired devices, but thieves cannot readily overwrite a legitimate owner's contact information. Initial setup may be detected by conventional means, and entry of a “set owner information” command may be detected using conventional means for detecting commands and for distinguishing between commands.

During a prompting step 304, the device 226 prompts the user to enter owner information. The beginning of such a prompt sequence is shown in FIG. 1. The prompt sequence is communicated to the user through the user interface 200. The prompt may display 306 current owner information, such as either dummy information placed in the device at the factory as an example, or actual owner information placed in the device by a past or present legitimate owner of the device.

The device 226 may also prompt for a PIN, password, or other code and verify 308 that the entered code satisfies a predetermined authentication criterion before permitting new owner information to be entered. The code may be the answer to a “hint” such as the owner's mother's maiden name, name of the store where the device was purchased, a birthday, or other information that is easily recalled by the owner but would require significant effort for a thief to determine. More conventional codes, such as a strong password in the form of an arbitrary string of letters and numbers not found in a dictionary or address book, may also be used. A predetermined number (e.g., three) of consecutive failures to enter the correct code may result in the device shutting down, sounding an alarm, or both, until the manufacturer is contacted, for instance. FIG. 3 shows the optional authentication step 308 occurring after the user is prompted for owner information, but step 308 could also be done before step 304 or integrated as one of several prompts in step 304.

The prompts for owner information should either strongly urge or flatly require the user to enter specific location information, such as a telephone (complete with area code), a full street address (with zip code), an email address (usemame and domain name), or some combination thereof The owner information is obtained 310 through the user interface 310 and then stored 312 in the memory 216. Owners may be permitted to correct or repeat information during step 310 before the information is permanently stored 312.

For instance, if the owner information will be entered as spoken data, a first prompt might be “To make it easier to reach you in case I am lost or stolen, I will now record some information that will make that possible. The information you are about to record will be repeated out loud each time my on switch is pressed. To begin, please state your first and last name”. After the owner's name is record, the second prompt could be “Please spell your last name”. Then a third prompt could be “Please be ready to state an email address where you can be reached. When you're ready, press the ‘continue’ key or say ‘continue’.” After entering a continue command, the user hears the prompt “Please say your email address”, and then after the email address is recorded, the prompt “Please spell your email address” is given and the spelling of the address is recorded.

Of course, different owner information can be obtained and stored in different embodiments. The prompts and recording can also be visual, and typed, for instance, rather than being spoken. A free form prompt can also be used, which does not specify the desired owner information field by field but simply prompts the user to “enter your postal address, your email address, or both” for instance.

FIG. 4 illustrates methods for displaying owner information that has been previously stored according to FIG. 3 or otherwise. As indicated, owner information may be displayed in response to detecting 400 that the device 226 has just been turned on, in response to detecting 402 that the device has just been turned off, and/or in response to a specific command 404. Known power-on self test technology may be used to detect 400 power-on, and known power-shutdown technology may similarly be used in step 402. Comments above regarding technologies to assist implementation of step 302 also apply to step 404.

In some embodiments, a check 406 is then performed to see whether the owner information store is present. Suitable tests include those discussed in connection with the link 224 between the primary components 204 of the device 226 and the memory 216 or a package containing the memory 216. In some embodiments, no explicit checking step 406 is performed; if the memory 216 is present the device functions and if the memory 216 is not present, then the device does not function or else functions in a severely limited way.

If the store 202 and its memory 216 are found 408, and are intact and apparently functioning as intended and in an authorized manner, then the owner information is displayed 410 by the user interface 200. For instance, the device 226 may say out loud, “My owner is” and then repeat the recorded information previously stored 312 in the memory 216 or display the owner's typed name and address on the screen 106.

Unlike engraving tools, adhesive labels, and the like, the ownership labeling provided by the invention is not necessarily always on display. Instead, the owner information may be displayed 410 for a short time (e.g., 20 seconds each time the device powers on 400). Or the owner information may be displayed 410 for a longer period, if that does not interfere with use of the device 226 (e.g., by being superimposed for one minute on an underlying television picture). In some embodiments, however, ownership information is displayed whenever the device 226 is on, e.g., a display screen on a car computer may constantly display the car owner's name and telephone number.

If the store 202 is not found 412 or if it is found but contains no owner information, then the device 226 may display an error message. The device 226 may also display 414 a warning message, such as “WARNING: Ownership of this device is not clear!” The device 226 may also be disabled 416 if the store 202 is not found 412 or if it is found but contains no owner information. This may be accomplished as discussed above in connection with the link 224, or using software to lock out users, in a manner similar to that done when a required password is not provided.

In summary, the owner identification option which is presented during step 304 and/or presented by a prompts routine 208 may be part of a menu-driven setup routine which many or all consumers will perform. Such routines may also automatically identify available cable channels, for instance, register devices and consumers with the device manufacturer, or perform other conventional setup functions. Entry of the consumer identification information (i.e., owner information) may be accomplished using conventional interface 200 tools and techniques, such as menus, remote controls 104, keyboards, and so on.

The entered information is stored 312 in the device 226, and will be displayed thereafter. In some embodiments, the consumer identification information is displayed 410 for a brief period every time the device is powered on. In some embodiments, the consumer identification information is displayed 410 in response to a detected 404 “display ID” button press, “display ID” menu selection, or other request to display 410 the information. In some embodiments, display 410 occurs both in response to detected 400 power-up and in response to a detected 404 specific request for the information.

In some embodiments, the consumer identification information is stored 312 permanently in the device, burned into a digital memory 216 chip such as PROM or radio transponder integrated circuit in such a way that only factory technicians can readily remove the owner information or prevent it from being displayed without also breaking the device 226. In some embodiments, the consumer identification information is stored in password-protected form in the device, so the consumer can release 308 the lock on the information to allow another legitimate purchaser of the device to put 310 his or her own identification information in, replacing the original information. A copy of the password can be kept by the consumer and/or manufacturer with a copy of the serial number.

Devices 226 such as stereo equipment may lack a display 106 adequate to allow consumer identification information entry by way of pressing buttons or making menu selections. Accordingly, such devices may accept 310 audible consumer identification information. That is, during setup the consumer is prompted 304 by the device to speak the consumer's name, phone number (with area code), and/or other information. The consumer may be warned that only 10 seconds will be recorded (or whatever duration corresponds to the available storage 216 capacity). The consumer may also be able to play back the recording and either accept it or re-record over it during step 310. The final recorded response is then stored 312 in digital chips 216 in the device, either permanently or in password-protected form, as noted above.

The consumer's audible message can be replayed 410 whenever the device 226 is powered on 400 and/or in response to a specific request by pressing 404 a “Who Owns Me?” button or the like. Of course, TVs 100 and other devices with visual displays 106 may also record audible consumer identification information, either as a supplement to the visible consumer identification information or as a substitute for it. In either case, no separate database at a manufacturer or otherwise is needed to correlate the device 226 with the owner's contact information. The information needed is contained in the device itself, and is easily displayed to the public, without any special reader tool or display password being needed.

If a burglar or other potential thief recognizes the “Who Owns Me?” button on an inventive device 226 and realizes that a pawn shop may be reluctant to accept a device that easily identifies itself 410 as belonging to someone other than the burglar, then the burglar may decide not to steal the device. If the device 226 is stolen, then police, merchants, prosecutors, and consumers can operate the device according to the invention to identify 410 the device's proper owner. This helps restore devices 226 to their owners (thereby lowering insurance costs), and helps prosecutors make their case against burglars and against criminals who knowingly or recklessly deal in stolen goods.

The user interface 200 and the information store 202 contain processors, memory, supporting circuits such as clocks and I/O circuits, as needed to carry out the operations described and claimed. The processor may be an “off-the-shelf” microprocessor, or it may use a special purpose processing device such as an ASIC, PAL, PLA, PLD, Field Programmable Gate Array, or other customized or programmable device. The memory may include static RAM, dynamic RAM, flash memory, ROM, PROM, EPROM, EEPROM, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software. Suitable software to assist in implementing the invention is readily provided by those of skill in the pertinent art(s) using the teachings presented here and programming languages and tools such as C++, C, APIs, SDKs, assembly, firmware, microcode, and/or other languages and tools.

Although particular embodiments of the present invention are expressly illustrated and described individually herein, it will be appreciated that discussion of one type of embodiment also extends to other embodiment types. For instance, the description of the methods illustrated in FIGS. 3 and 4 also helps describe the systems and devices in FIGS. 1 and 2, and vice versa. All claims as filed are part of the specification and thus help describe the invention, and repeated claim language may be inserted outside the claims as needed.

As used herein, terms such as “a” and “the” and designations such as “prompt”, are inclusive of one or more of the indicated element. In particular, in the claims a reference to an element generally means at least one such element is required.

The invention may be embodied in other specific forms without departing from its essential characteristics. The described embodiments are to be considered in all respects only as illustrative and not restrictive. Headings are for convenience only. The scope of the invention is, therefore, indicated by the appended claims rather than by the foregoing description. All changes which come within the meaning and range of equivalency of the claims are to be embraced within their scope.

What is claimed and desired to be secured by patent is:

1. A device having self-contained public identification of the device's owner, the device comprising:
primary function components;
an owner information store including a non-volatile memory electronically storing owner information which includes at least one location value for specifying to the public a location for contacting the device's owner;
a user interface in operable connection with the owner information store, the user interface including a prompts portion which prompts a user for owner information that will permit the device's owner to be located if the device is lost or stolen, the user interface further including an owner information display portion which displays on the device owner information retrieved from the non-volatile memory, the displayed owner information including at least one location value specifying to the public a location for contacting the device's owner.

2. The device of claim 1, wherein the primary function components comprise at least one of a television receiver, a radio receiver, a computer operating system, an internal combustion engine, a heating element, and a refrigeration compressor.

3. The device of claim 1, wherein the user interface comprises at least one of a microphone, a keyboard, a wireless remote control, a button, and a visual menu.

4. The device of claim 1, wherein the user interface comprises at least one of a visual display and an audio speaker.

5. The device of claim 1, wherein the non-volatile memory comprises at least one of an EPROM and an EEPROM.

6. The device of claim 1, wherein the owner information store further comprises an authorization module which requires a verified code before allowing write access to the non-volatile memory.

7. The device of claim 1, wherein the primary function components are linked with a package containing the non-volatile memory such that removal of the package from the device will hinder proper functioning of the primary function components.

8. A device having self-contained public identification of the device's owner, the device comprising:
a prompting means for prompting a user for owner information which will permit the device's owner to be located if the device is lost or stolen;
an owner information obtaining means for obtaining from the user owner information which includes at least one location value specifying to the public a location for contacting the device's owner, and for storing obtained information in a non-volatile memory in the device;
a detecting means for detecting a predetermined condition which calls for the owner information to be displayed, the predetermined condition not requiring entry of a password or other code and requiring use only of the device itself and its controls; and
a displaying means for displaying on the device, in response to the detecting means, owner information retrieved from the non-volatile memory, the displayed owner information including at least one location value specifying to the public a location for contacting the device's owner.

9. The device of claim 8, wherein the obtaining means obtains, and the displaying means displays, at least one of the following as an owner information location value: a voice telephone number, a fax telephone number, an email address, a street address, a post office box mailing address.

10. The device of claim 8, wherein the prompting means prompts the user in response to a command to set owner information in the device.

11. The device of claim 8, further comprising an authorization module which obtains an authorization code from the user and verifies that authorization code before permitting storage of owner information in the non-volatile memory.

12. The device of claim 8, wherein the detecting means detects at least one of power-on in the device, power-off in the device, and entry of a command in the device to display owner information.

13. The device of claim 8, wherein the owner information obtaining means comprises at least one of a keyboard, a button, a touch screen, a microphone, and a remote control.

14. The device of claim 8, wherein the owner information displaying means comprises at least one of a visual display screen and an audio speaker.

15. A method for placing and using owner information in a device, comprising the steps of:
prompting a user for owner information which will permit the device's owner to be located if the device is lost or stolen;
obtaining from the user owner information which includes at least one location value specifying to the public a location for contacting the device's owner;
electronically storing obtained owner information in a non-volatile memory in the device;
detecting a predetermined condition which calls for the owner information to be displayed, the predetermined condition not requiring entry of a password or other code and requiring use only of the device itself and its controls; and
in response to the detecting step, displaying on the device owner information retrieved from the non-volatile memory, the displayed owner information including at least one location value specifying to the public a location for contacting the device's owner.

16. The method of claim 15, wherein the obtaining step obtains, and the displaying step displays, at least one of the following as an owner information location value: a voice telephone number, a fax telephone number, an email address, a street address, a post office box mailing address.

17. The method of claim 15, wherein the prompting step occurs in response to at least one of detecting that the device is being initially set-up after leaving a factory, and detecting that the device was given a command to set owner information in the device.

18. The method of claim 15, further comprising the steps of obtaining an authorization code from the user, and verifying the authorization code, before electronically storing in a non-volatile memory in the device the owner information obtained from the user.

19. The method of claim 15, wherein the predetermined condition which calls for the owner information to be displayed includes at least one of detecting power-on in the device, detecting power-off in the device, and detecting entry of a command in the device to display owner information.

20. The method of claim 15, wherein the step of obtaining owner information receives characters from a keyboard, and the displaying step displays characters visually.

21. The method of claim 15, wherein the step of obtaining owner information records audio data, and the displaying step plays recorded audio data.

22. A method for accepting and storing owner information in a device, comprising the steps of:
prompting a user for owner information which will permit the device's owner to be located if the device is lost or stolen;
obtaining from the user owner information which includes at least one location value specifying to the public a location for contacting the device's owner; and
electronically storing obtained owner information in a non-volatile memory in the device.

23. The method of claim 22, wherein the obtaining step obtains at least one of the following as an owner information location value: a voice telephone number, a fax telephone number, an email address, a street address, a post office box mailing address.

24. The method of claim 22, wherein the prompting step occurs in response to at least one of detecting that the device is being initially set-up after leaving a factory, and detecting that the device was given a command to set owner information in the device.

25. The method of claim 22, wherein the prompting step displays current owner information before obtaining owner information from the user.

26. The method of claim 22, further comprising the steps of obtaining an authorization code from the user, and verifying the authorization code, before electronically storing in a non-volatile memory in the device the owner information obtained from the user.

27. A method for publicly displaying owner information previously stored in a device, comprising the steps of:
detecting a predetermined condition which calls for the owner information to be displayed, the predetermined condition not requiring entry of a password or other code and requiring use only of the device itself and its controls;
in response to the detecting step, attempting to recall the owner information from a non-volatile memory in the device;
if the attempting step succeeds then displaying on the device owner information which includes at least one location value specifying to the public a location for contacting the device's owner.

28. The method of claim 27, wherein the predetermined condition includes at least one of detecting power-on in the device, detecting power-off in the device, and detecting entry of a command in the device to display owner information.

29. The method of claim 27, wherein the displaying step displays at least one of the following as an owner information location value: a voice telephone number, a fax telephone number, an email address, a street address, a post office box mailing address.

30. The method of claim 27, wherein the attempting step fails, and the device displays at least one of an error message and a warning message instead of displaying owner information.

31. The method of claim 27, wherein the attempting step fails, and the device is disabled so it fails to function properly.
